(19) United States
(12) Patent Application Publication
(10) Pub. No.: US 2019/0362703 A1
(43) Pub. Date: Nov. 28, 2019

(54) WORD VECTORIZATION MODEL LEARNING DEVICE, WORD VECTORIZATION DEVICE, SPEECH SYNTHESIS DEVICE, METHOD THEREOF, AND PROGRAM

(71) Applicant: NIPPON TELEGRAPH AND TELEPHONE CORPORATION, Chiyoda-ku (JP)

(72) Inventors: Yusuke IJIMA, Yokosuka-shi (JP); Nobukatsu HOJO, Yokosuka-shi (JP); Taichi ASAMI, Yokosuka-shi (JP)

(73) Assignee: NIPPON TELEGRAPH AND TELEPHONE CORPORATION, Chiyoda-ku (JP)

(21) Appl. No.: 16/485,067

(22) PCT Filed: Feb. 14, 2018
(86) PCT No.: PCT/JP2018/004995

§ 371 Date: Aug. 9, 2019

(30) Foreign Application Priority Data
Feb. 15, 2017 (JP) 2017-025901

(51) Int. Cl. G10L 13/06; G10L 13/08; G10L 25/30; G06N 3/08; G06N 20/00

(52) U.S. Cl. CPC G10L 13/06; G10L 13/08; G06N 20/00; G06N 3/08; G10L 25/30

(57) ABSTRACT

Provided is a word vectorization device that converts a word to a word vector considering the acoustic feature of the word. A word vectorization model learning device comprises a learning part for learning a word vectorization model by using a vector w_{L,s}(t) indicating a word y_{L,s}(t) included in learning text data, and an acoustic feature amount af_{L,s}(t) that is an acoustic feature amount of speech data corresponding to the learning text data and that corresponds to the word y_{L,s}(t). The word vectorization model includes a neural network that receives a vector indicating a word as an input and outputs the acoustic feature amount of speech data corresponding to the word, and the word vectorization model is a model that uses an output value from any intermediate layer as a word vector.

### TECHNICAL FIELD

The present invention relates to a technique for vectorizing words used in natural language processing such as speech synthesis and speech recognition.

### BACKGROUND ART

In the field of natural language processing and the like, a technique for vectorizing words has been proposed. For example, Word2Vec is known as a technique for vectorizing words (see Non Patent Literature 1, for example). A word vectorization device 90 receives a series of words to be vectorized at the input, and outputs word vectors representing the words (see FIG. 1). A word vectorization technique, such as Word2Vec, vectorizes words so that they can be easily operated in calculators. For this reason, the speech synthesis, speech recognition, machine translation, dialog system, search system, and other various natural language processing technologies operated in calculators use a word vectorization technique.

### PRIOR ART LITERATURE

### Non-Patent Literature

Non-patent literature 1: Tomas Mikolov, Kai Chen, Greg Corrado, Jeffrey Dean, “Efficient estimation of word representations in vector space”, 2013, ICLR

### SUMMARY OF THE INVENTION

### Problems to be Solved by the Invention

A model f used in the current word vectorization technique is learned using only information on the expression of a word (text data) tex_{L} (see FIG. 2). For example, in Word2Vec, a relationship between words is learned by learning a neural network (word vectorization model) 92, such as Continuous Bag of Words (CBOW, see FIG. 3A) that estimates a certain word from the preceding and succeeding words, or Skip-grain (see FIG. 3B) that estimates the preceding and succeeding words from a certain word. Therefore, the obtained word vector results from vectorization based on the definition of the word (for example, PoS), and the like, and cannot take the pronunciation or other information into consideration. For example, the English words “won't”, “want”, and “don't”, which have a stress is in the same position and have substantially the same phonetic symbols, are thought to have substantially the same pronunciation. However, Word2Vec and the like cannot convert these words to similar vectors.

An object of the present invention is to provide a word vectorization device for converting a word into a word vector considering acoustic features of the word, a word vectorization model learning device for learning a word vectorization model used in the word vectorization device, a speech synthesis device for generating synthesized speech data using a word vector, a method thereof, and a program.

### Means to Solve the Problems

To solve the above-mentioned problems, according to one aspect of the present invention, a word vectorization model learning device comprises: a learning part for learning a word vectorization model by using a vector w_{L,s}(t) indicating a word y_{L,s}(t) included in learning text data, and an acoustic feature amount af_{L,s}(t) that is an acoustic feature amount of speech data corresponding to the learning text data and that corresponds to the word y_{L,s}(t). The word vectorization model includes a neural network that receives a vector indicating a word as an input and outputs the acoustic feature amount of speech data corresponding to the word, and the word vectorization model is a model that uses an output value from any intermediate layer as a word vector.

To solve the above-mentioned problems, according to another aspect of the present invention, a word vectorization model learning method to be executed by a word vectorization model learning device comprises: a learning step for learning a word vectorization model by using a vector w_{L,s}(t) indicating a word y_{L,s}(t) included in learning text data, and an acoustic feature amount af_{L,s}(t) that is an acoustic feature amount of speech data corresponding to the learning text data and that corresponds to the word y_{L,s}(t). The word vectorization model includes a neural network that receives a vector indicating a word as an input and outputs the acoustic feature amount of speech data corresponding to the word, and the word vectorization model is a model that uses an output value from any intermediate layer as a word vector.

### Effects of the Invention

The present invention has the effect of allowing word vectors considering acoustic features to be obtained.

### BRIEF DESCRIPTION OF THE DRAWINGS

FIG. 1 is a diagram for explaining a word vectorization device according to a prior art;

FIG. 2 is a diagram for explaining a word vectorization model learning device according to a prior art;

FIG. 3A shows a neural network of CBOW;

FIG. 3B shows a neural network of Skip-grain;

FIG. 4 is a functional block diagram of a word vectorization model learning device according to the first, second, and third embodiments;

FIG. 5 is a diagram showing an example of a processing flow in a word vectorization model learning device according to the first, second, and third embodiments;

FIG. 6 is a diagram for explaining a word vectorization model learning device according to the first embodiment;

FIG. 7 is a diagram showing an example of word segmentation information;

FIG. 8 is a functional block diagram of a word vectorization device according to the first and third embodiments;

FIG. 9 is a diagram showing an example of a processing flow in a word vectorization device according to the first and third embodiments;

FIG. 10 is a functional block diagram of a speech synthesis device according to the fourth and fifth embodiments;

FIG. 11 is a diagram showing an example of a processing flow in a speech synthesis device according to the fourth and fifth embodiments;

FIG. 12 is a diagram showing information on a speech recognition corpus and a speech synthesis corpus;

FIG. 13A is a diagram showing a cosine similarity between word vectors obtained according to the fourth embodiment and the prior art for a sentence (1);

FIG. 13B is a diagram showing a cosine similarity between word vectors obtained according to the fourth embodiment and the prior art for a sentence (2);

FIG. 14 is a diagram showing RMS errors obtained according to the prior art, the fourth embodiment, and the fifth embodiment; and

FIG. 15 is a diagram showing correlation coefficients obtained according to the prior art, the fourth embodiment, and the fifth embodiment.

### DETAILED DESCRIPTION OF THE EMBODIMENTS

Embodiments of the present invention will now be described. In the accompanying drawings used for description made below, components having the same function or steps involving the same processing are denoted by the same reference numeral and duplicate explanation will be omitted. In the description made below, the processing performed for each vector, matrix, or other elements shall be applied to all elements of the vector or its matrix unless otherwise specified.

### Points of First Embodiment

In recent years, a large amount of speech data and its transcribed text (hereinafter also referred to as a speech recognition corpus) have been prepared as learning data for speech recognition and the like. In this embodiment, speech data is used as learning data of a word vectorization model (word (morpheme) notation) in addition to text, which is conventionally used. For example, a model that estimates the acoustic feature amount (spectrum, pitch parameter, and the like) of a word and its temporal variations from an input word (text data) is learned using a large amount of speech data and text, and this model is used as a word vectorization model.

Learning a model in this manner allows a vector considering the similarity of pronunciation or other features between words to be extracted. Further, use of word vectors considering similarity of pronunciation or other features can improve the performance of speech processing techniques, such as speech synthesis and speech recognition.

### Word Vectorization Model Learning Device According to First Embodiment

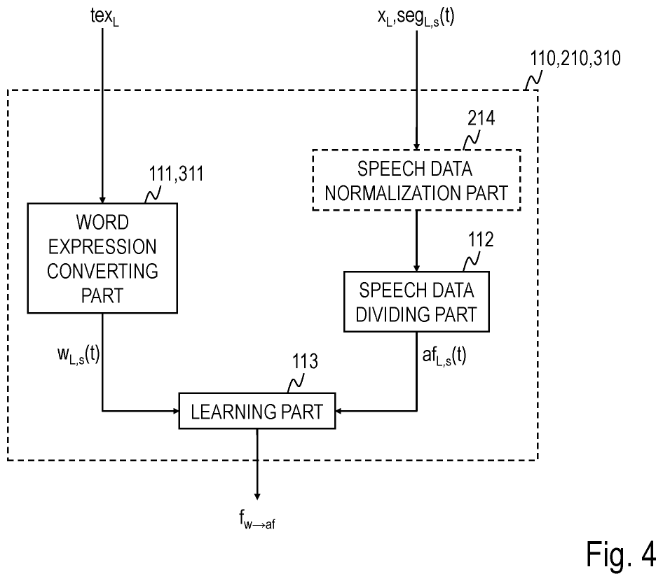

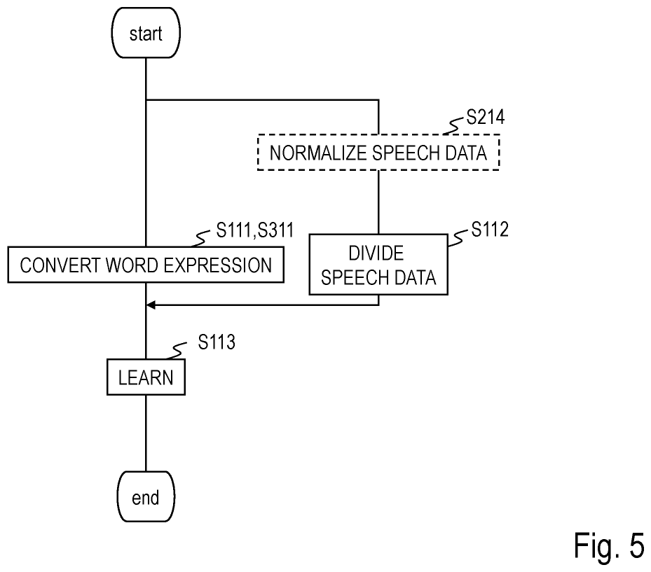

FIG. 4 is a functional block diagram of a word vectorization model learning device 110 according to the first embodiment, and FIG. 5 shows the processing flow therein.

The word vectorization model learning device 110 receives (1) learning text data tex_{L}, (2) information x_{L} based on speech data corresponding to learning text data tex_{L}, and (3) word segmentation information seg_{L,s}(t) indicating when word y_{L,s}(t) in the speech data has been spoken at the input, and outputs a word vectorization model f_{w→af} learned using these pieces of information.

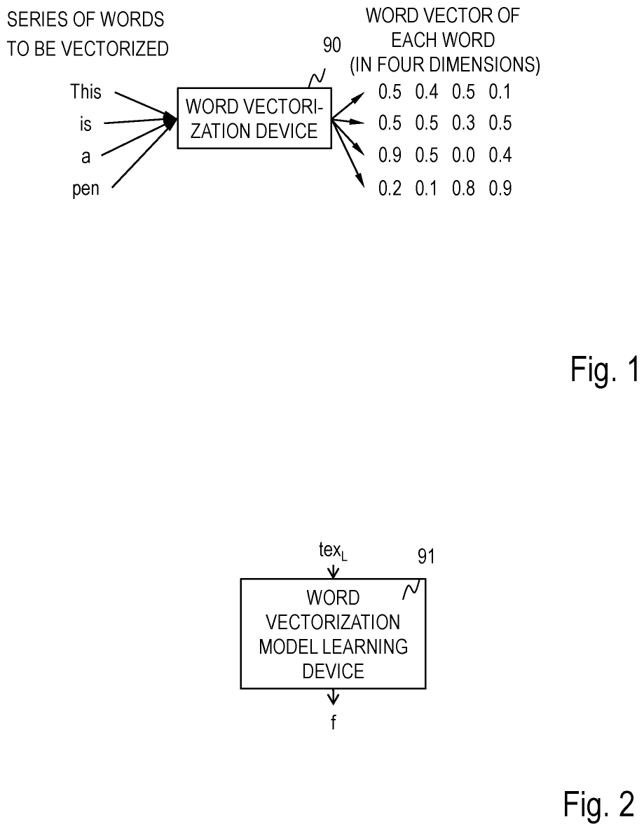

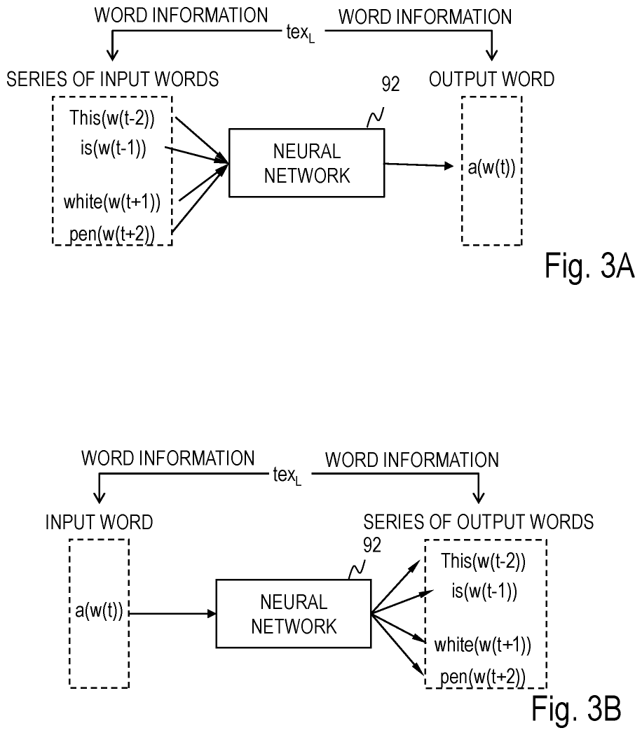

The major difference from a conventional word vectorization model learning device 91 (see FIG. 2) is that the word vectorization model learning device 91 uses only text data as learning data of the word vectorization model, whereas this embodiment uses speech data and its text data.

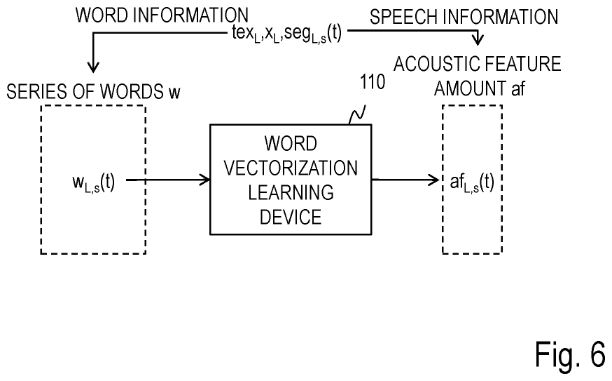

In this embodiment, at the time of learning, a neural network (a word vectorization model) that estimates, from a word, the acoustic feature amount of the word is learned by using word information (information w_{L,s}(t) indicating the word y_{L,s}(t) included in the learning text data tex_{L}) as the input of the word vectorization model f_{w→af} and the speech information (the acoustic feature amount af_{L,s}(t) of the word y_{L,s}(t)) as the output (see FIG. 6).

The word vectorization model learning device 110 consists of a computer including a CPU, a RAM, and a ROM that stores a program for executing the following processing, and has the following functional configuration.

The word vectorization model learning device 110 includes a word expression converting part 111, a speech data dividing part 112, and a learning part 113.

Learning data used for learning a word vectorization model will now be described.

For example, a corpus (a speech recognition corpus) consisting of a large amount of speech data and its transcribed text data can be used as learning text data tex_{L} and speech data corresponding to the learning text data tex_{L}. In other words, it consists of a large amount of speech (speech data) spoken by a person and sentences (text data) added to the speech (each has S sentences). For this speech data, only speech data spoken by one speaker or a mixture of speech data spoken by various speakers may be used.

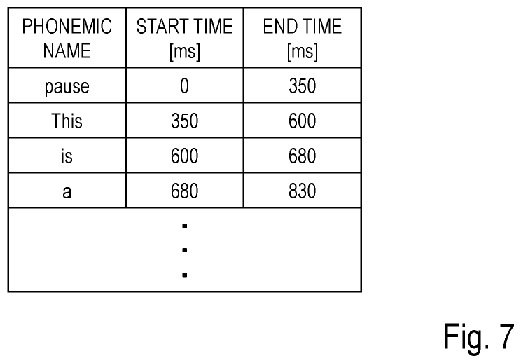

In addition, word segmentation information seg_{L,s}(t) (see FIG. 7) indicating when the word y_{L,s}(t) in the speech data was spoken is also given. Although the start time and the end time of each word are used as word segmentation information in the example shown in FIG. 7, other information may be used. For example, when the end time of a word coincides with the start time of the next word, either one of the start time and the end time may be used as word segmentation information. Alternatively, the start time of the sentence may be designated and only the speaking time may be used as the word segmentation information. For example, with settings in which “pause”=350, “This”=250, “is”=80, . . . , the start time and end time of each word can be specified. In short, the word segmentation information may be any information that can indicate when the word y_{L,s}(t) was spoken. This word segmentation information may be given manually, or may be automatically given from speech data and text data by using a speech recognizer or the like. In this embodiment, information x_{L}(t) and word segmentation information seg_{L,s}(t) based on the speech data are input to the word vectorization model learning device 110. However, a configuration may be adopted in which only the information x_{L}(t) based on the speech data is input to the word vectorization model learning device 110 and the word boundary of each word is given by forced alignment in the word vectorization model learning device 110, thereby obtaining word segmentation information seg_{L,s}(t).

In addition, although normal text data includes no words expressing silence during speech (such as short pause), this embodiment uses the word “pause” expressing silence in order to ensure consistency with speech data.

Information x_{L} based on speech data may be actual speech data or an acoustic feature amount that can be acquired from the speech data. In this embodiment, it is assumed to be an acoustic feature amount (spectrum parameter and pitch parameter (F0)) extracted from speech data. It is also possible to use the spectrum, the pitch parameter, or both as an acoustic feature amount. Alternatively, it is also possible to use an acoustic feature amount (for example, mel-cepstrum, aperiodicity index, log F0, or voiced/unvoiced flag) that can be extracted from speech data by signal processing or the like. In the case where the information x_{L} based on the speech data is actual speech data, a configuration for extracting the acoustic feature amount from the speech data may be provided.

Processing in each part will now be described.

### Word Expression Converting Part 111

The word expression converting part 111 receives the learning text data tex_{L} as an input and converts the word y_{L,s}(t) included in the learning text data tex_{L} to a vector w_{L,s}(t) indicating the word y_{L,s}(t) (S111), and outputs it.

The word y_{L,s}(t) in the learning text data tex_{L} is converted to an expression (numerical expression) usable in the learning part 113 in the subsequent stage. It should be noted that a vector w_{L,s}(t) is also referred to as expression-converted word data.

The most common example of a numeric expression of a word is a one hot expression. For example, if N types of words are included in the learning text data tex_{L}, each word is treated as an N-dimensional vector w_{L,s}(t) in one hot expression.

w_{L,s}(t)=[w_{L,s}(t)(1), . . . , w_{L,s}(t)(n), . . . , w_{L,s}(t)(N)]

Here, w_{L,s}(t) is the vector of the t-th (1≤t≤Tₛ) (Tₛ is the number of words included in the s-th sentence) word in the s-th (1≤s≤S) sentence in the learning text data tex_{L}. Therefore, processing is performed on all s and all t in each part. In addition, w_{L,s}(t)(n) represents the n-dimensional information of w_{L,s}(t). One-hot expression constructs a vector in which the dimension w_{L,s}(t)(n) corresponding to the word is 1 and the other dimensions are 0.

### Speech Data Dividing Part 112

The speech data dividing part 112 receives word segmentation information seg_{L,s}(t) and an acoustic feature amount, which is information x_{L} based on speech data, as inputs and uses the word segmentation information seg_{L,s}(t) to divide the acoustic feature amount according to the division of the word y_{L,s}(t) (S112), and outputs acoustic feature amount af_{L,s}(t) of the divided speech data.

In this embodiment, in the learning part 113 in the subsequent stage, the divided acoustic feature amount af_{L,s}(t) needs to be expressed as the vector of an arbitrary fixed length (the number of dimensions D). For this reason, the acoustic feature amount af_{L,s}(t) after division of each word is obtained by the following procedure.

(1) Based on the time information about the word y_{L,s}(t) in the word segmentation information seg_{L,s}(t), a time-series acoustic feature amount is divided for each word y_{L,s}(t). For example, when the frame shift of the speech data is 5 ms, in the example shown in FIG. 7, the acoustic feature amount from the first frame to the 70th frame is obtained as the acoustic feature amount of the silence word “pause”. Similarly, for the word “This”, the acoustic feature amount from the 71st frame to the 120th frame is obtained.
(2) Since the acoustic feature amounts of the words obtained in the above (1) have different numbers of frames, the number of dimensions differs between the acoustic feature amounts of the words. For this reason, it is necessary to convert the obtained acoustic feature amount of each word into a vector with a fixed length. The simplest way of conversion is to convert acoustic feature amounts having different numbers of frames into those with an arbitrary fixed number of frames. This conversion can be achieved by linear interpolation or the like.

In addition, data obtained by dimensionally compressing the obtained after-division acoustic feature amount by some sort of dimension compression method can be used as after-division acoustic feature amount af_{L,s}(t). Examples of dimensional compression method that can be used here include principal component analysis (PCA), discrete cosine transform (DCT), and neural network-based self-encoder (auto encoder).

### Learning Part 113

The learning part 113 receives the vector w_{L,s}(t) and the acoustic feature amount af_{L,s}(t) of the divided speech data as inputs, and learns the word vectorization model f_{w→af} using these values (S113). It should be noted that a word vectorization model is a neural network that converts a vector w_{L,s}(t) (for example, N-dimensional one hot expression) representing a word into the acoustic feature amount (for example, a D-dimensional vector) of the speech data corresponding to the word. For example, the word vectorization model f_{w→af} is expressed by the following equation.

\hat{ }af_{L,s}(t)=f_{w→af}(w_{L,s}(t))

Examples of neural network that can be used in this embodiment include not only a normal multilayer perceptron (MLP) but also neural networks that can consider the preceding and succeeding words, such as the Recurrent Neural Network (RNN) and the RNN-LSTM (long short term memory), and any neural network obtained by combining them.

### Word Vectorization Device According to First Embodiment

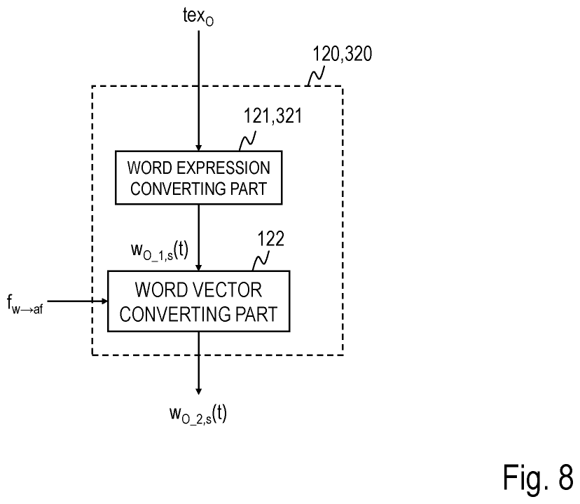

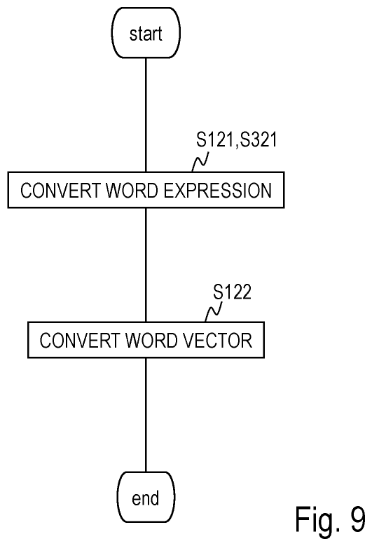

FIG. 8 is a functional block diagram of a word vectorization device 120 according to the first embodiment, and FIG. 9 shows the processing flow therein.

The word vectorization device 120 receives text data texₒ to be vectorized as an input, converts the word y_{o,s}(t) included in the text data texₒ to a word vector w_{o_2,s}(t) by using the learned word vectorization model f_{w→af}, and outputs it. Note that, in the word vectorization device 120, 1≤s≤Sₒ where Sₒ is the total number of sentences included in the text data texₒ to be vectorized, and 1≤t≤Tₛ where Tₛ is the total number of words y_{o,s}(t) included in the sentence s included in the text data texₒ to be vectorized.

The word vectorization device 120 consists of a computer including a CPU, a RAM, and a ROM that stores a program for executing the following processing, and has the following functional configuration.

The word vectorization device 120 includes a word expression converting part 121 and a word vector converting part 122. Prior to vectorization, the word vectorization device 120 receives the word vectorization model f_{w→af} in advance and registers it to the word vector converting part 122.

### Word Expression Converting Part 121

The word expression converting part 121 receives text data texₒ as an input and converts the word y_{o,s}(t) included in the text data texₒ to a vector w_{o_1,s}(t) indicating the word y_{o,s}(t) (S121), and outputs it. Any converting method designed for the word expression converting part 111 may be used.

### Word Vector Converting Part 122

The word vector converting part 122 receives vector w_{o_1,s}(t) as an input, converts the vector w_{o_1,s}(t) to a word vector w_{o_2,s}(t) by using the word vectorization model f_{w→af} (S122), and outputs it. For example, the forward propagation processing of the neural network of the word vectorization model f_{w→af} is performed using the vector w_{o_1,s}(t) as an input and the output value (bottleneck feature) of an arbitrary middle layer (bottleneck layer) is output as the word vector w_{o_2,s}(t) of the word y_{o,s}(t), thereby achieving conversion from the vector w_{o_1,s}(t) to the word vector w_{o_2,s}(t).

### Effects

With the above configuration, the word vector w_{o_2,s}(t) considering acoustic features can be obtained.

### Modification

The word vectorization model learning device may include only a learning part 130. For example, the vector w_{L,s}(t) indicating a word y_{L,s}(t) included in learning text data and the acoustic feature amount af_{L,s}(t) corresponding to the word y_{L,s}(t) may be calculated by another device. Similarly, the word vectorization device may include only the word vector converting part 122. For example, the vector w_{o_1,s}(t) indicating a word y_{o,s}(t) included in text data to be vectorized may be calculated by another device.

### Second Embodiment

Points different from those of the first embodiment will be mainly described.

In the first embodiment, in the case where the speech of various speakers are included as speech data, the speech data greatly varies depending on the speaker characteristics. Therefore, it is difficult to perform word vectorization model learning with high accuracy. To solve this, in the second embodiment, for each speaker, normalization is performed on the acoustic feature amount which is the information x_{L} based on the speech data. This configuration alleviates the problem that the accuracy of word vectorization model learning is lowered due to variations in speaker characteristics.

FIG. 4 is a functional block diagram of a word vectorization model learning device 210 according to the second embodiment, and FIG. 5 shows the processing flow therein.

The word vectorization model learning device 210 includes a word expression converting part 111, a speech data normalization part 214 (indicated by the dashed line in FIG. 4), a speech data dividing part 112, and a learning part 113.

### Speech Data Normalization Part 214

The speech data normalization part 214 receives an acoustic feature amount, which is information x_{L} based on speech data, normalizes the acoustic feature amount of the speech data corresponding to the learning text data of the same speaker (S121), and outputs it.

In the case where the information about the speaker of each sentence is given in the acoustic feature amount, a way of normalization is, for example, to determine the mean and the variance from the acoustic feature amount of the same speaker, and determine the z-score. For example, in the case where no information about the speaker is given, it is assumed that the speakers of the sentences are different, and the mean and the variance are determined for each sentence from the acoustic feature amount, and the z-score is determined. Subsequently, the z-score is used as a normalized acoustic feature amount.

The speech data dividing part 112 uses the normalized acoustic feature amount.

### Effects

With this configuration, the same effects as those in the first embodiment can be obtained. Further, it alleviates the problem that the accuracy of word vectorization model learning is lowered due to variations in speaker characteristics.

### Third Embodiment

Points different from those of the first embodiment will be mainly described.

In the first and second embodiments, word vectorization model learning uses an acoustic feature amount corresponding to speech data and the text data thereof. However, the number N of types of words included in generally usable speech data is small with respect to a large amount of text data available from the Web and the like. Therefore, the problem arises that unknown words tend to occur more frequently for word vectorization models in which learning is performed only with conventional learning text data.

In this embodiment, in order to solve the problem, the word expression converting parts 111 and 121 use a word vectorization model that learns only with conventional learning text data. The word expression converting parts 311 and 321 having a difference will be described (see FIGS. 4 and 8). It is also possible to combine this embodiment and the second embodiment together.

### Word Expression Converting Part 311

The word expression converting part 311 receives the learning text data tex_{L} as an input and converts the word y_{L,s}(t) included in the learning text data tex_{L} to a vector w_{L,s}(t) indicating the word y_{L,s}(t) (S311, see FIG. 5), and outputs it.

In this embodiment, for each word y_{L,s}(t) in the learning text data tex_{L}, with the use of a word vectorization model based on language information, a word is converted to an expression (numerical expression) that can be used in the learning part 133 in the subsequent stage, thereby obtaining a vector w_{L,s}(t). The word vectorization model based on language information can be Word2Vec or the like mentioned in Non Patent Literature 1.

In this embodiment, as in the first embodiment, a word is first converted to a one hot expression. As the number of dimensions N at this time, the first embodiment uses the number of types of words in the learning text data tex_{L}, whereas this embodiment uses the number of types of words in the learning text data that was used for learning of the word vectorization model based on language information. Next, for the obtained vector of the one hot expression of each word, a vector w_{L,s}(t) is obtained by using the word vectorization model based on language information. Although the vector conversion method varies depending on the word vectorization model based on language information, in the case of Word2Vec, as in the present invention, forward propagation processing is performed to extract the output vector of the intermediate layer (bottleneck layer), thereby obtaining the vector w_{L,s}(t).

The same processing is performed in the word expression converting part 321 (see S321 in FIG. 9).

### Effects

With such a configuration, the same effects as those in the first embodiment can be obtained. Moreover, the frequency of occurrence of unknown words can be made substantially the same as in conventional word vectorization models.

### Fourth Embodiment

In this embodiment, an example in which word vectors generated in the first to third embodiments are used for speech synthesis will be described. Note that, not surprisingly, word vectors can be used for applications other than speech synthesis and this embodiment does not limit the use of word vectors.

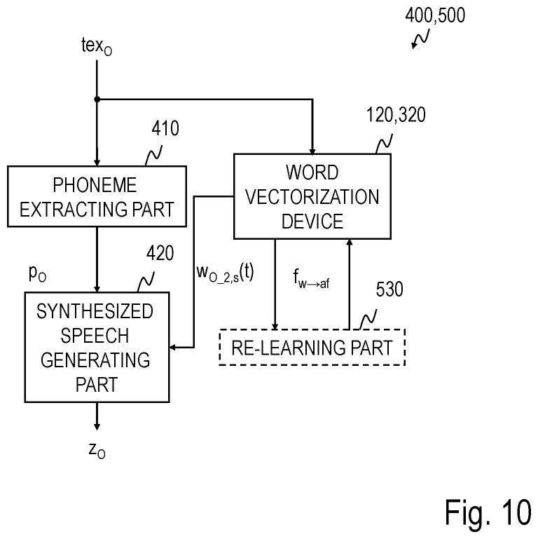

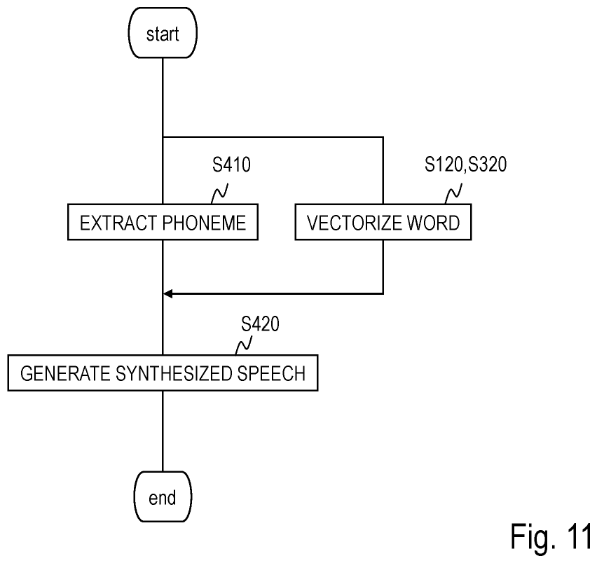

FIG. 10 is a functional block diagram of a speech synthesis device 400 according to the fourth embodiment, and FIG. 11 shows the processing flow therein.

The speech synthesis device 400 receives text data texₒ for speech synthesis as an input, and outputs synthesized speech data zₒ.

The speech synthesis device 400 consists of a computer including a CPU, a RAM, and a ROM that stores a program for executing the following processing, and has the following functional configuration.

The speech synthesis device 400 includes a phoneme extracting part 410, a word vectorization device 120 or 320, and a synthesized speech generating part 420. The processing in the word vectorization device 120 or 320 is as described in the first or third embodiment (see S120 and S320). Prior to the speech synthesis processing, the word vectorization device 120 or 320 receives the word vectorization model f_{w→af} in advance and registers it to the word vector converting part 122.

### Phoneme Extracting Part 410

The phoneme extracting part 410 receives text data texₒ for speech synthesis as an input, extracts the phonemic information pₒ corresponding to the text data texₒ (S410), and outputs it. Note that any existing technique may be used as the phoneme extraction method, and an optimum technique may be selected as appropriate according to the usage environment and the like.

### Synthesized Speech Generating Part 420

The synthesized speech generating part 420 receives phonemic information pₒ and a word vector w_{o_2,s}(t) as inputs, generates synthesized speech data zₒ (S420), and outputs it.

For example, the synthesized speech generating part 420 includes a speech synthesis model. For example, the speech synthesis model is a model that receives phonemic information about a word and a word vector corresponding to the word as inputs, and outputs information for generating synthesized speech data related to the word (for example, a deep neural network (DNN) model). Information for generating synthesized speech data may be a mel-cepstrum, an aperiodicity index, F0, a voiced/unvoiced flag, or the like (a vector having these pieces of information as elements will hereinafter be also referred to as a feature vector). Prior to the speech synthesis processing, phonetic information corresponding to the text data for learning, a word vector, and a feature vector are given to learn a speech synthesis model. Further, the synthesized speech generating part 420 inputs the phonemic information pₒ and the word vector w_{o_2,s}(t) to the speech synthesis model described above, acquires a feature vector corresponding to the text data texₒ for speech synthesis, and generates synthesized speech data zₒ from the feature vector by using the vocoder or the like, and outputs it.

### Effects

With such a configuration, it is possible to generate synthesized speech data using a word vector that takes acoustic features into consideration, and it is possible to generate more natural synthesized speech data than before.

### Fifth Embodiment

Points different from those of the fourth embodiment will be mainly described.

In the speech synthesis method of the fourth embodiment, a word vectorization model is learned by any of the methods of the first to third embodiments. In the explanation of the first embodiment, the fact that a speech recognition corpus and the like can be used for learning a word vectorized model has been mentioned. Here, when the word vectorization model is learned using the speech recognition corpus, the acoustic feature amount varies depending on the speaker. For this reason, the obtained word vector is not always optimal for the speaker related to the speech synthesis corpus. To solve this problem, in order to obtain a word vector more suited to the speaker related to the speech synthesis corpus, the word vectorization model learned from the speech recognition corpus is re-learned using the speech synthesis corpus.

FIG. 10 is a functional block diagram of a speech synthesis device 500 according to the fifth embodiment, and FIG. 11 shows the processing flow therein.

The speech synthesis device 500 includes a phoneme extracting part 410, a word vectorization device 120 or 320, a synthesized speech generating part 420, and a re-learning part 530 (indicated by the dashed line in FIG. 10). The processing in the re-learning part 530 will now be explained.

### Re-Learning Part 530

Prior to re-learning, the re-learning part 530 preliminarily determines the vector w_{v,s}(t) and the acoustic feature amount af_{v,s}(t) of divided speech data by using speech data and text data obtained from the synthesis speech corpus. Note that the vector w_{v,s}(t) and the acoustic feature amount af_{v,s}(t) of the divided speech data can be obtained by the same method as that in the word expression converting part 111 or 311 and the speech data dividing part 112. Note that the acoustic feature amount af_{v,s}(t) of the divided speech data can be regarded as the acoustic feature amount of speech data for speech synthesis.

The re-learning part 530 re-learns the word vectorization model f_{w→af} by using the word vectorization model f_{w→af}, the vector w_{v,s}(t), and the acoustic feature amount af_{v,s}(t) of the divided speech data, and outputs the re-learned word vectorization model f_{w→af}.

The word vectorization devices 120 and 320 receive text data texₒ to be vectorized as an input, convert the word y_{o,s}(t) in the text data texₒ to a word vector w_{o_2,s}(t) by using the re-learned word vectorization model f_{w→af}, and output it.

### Effects

With such a configuration, the word vector can be optimized for the speaker related to the speech synthesis corpus, thereby achieving generation of synthesized speech data that is more natural than before.

### Simulation

### (Experimental Condition)

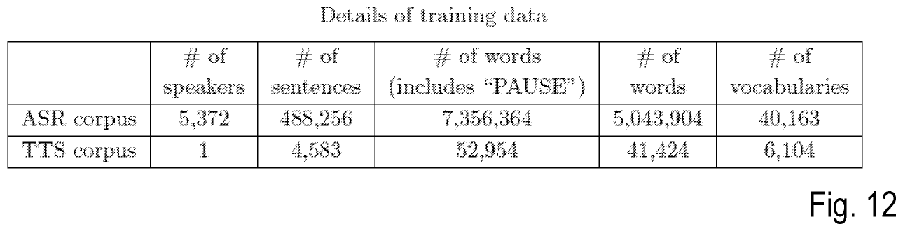

A speech recognition corpus (ASR corpus) of about 700 hours of speech by 5,372 English native speakers was used as large-scale speech data used for learning the word vectorization model f_{w→af}. Each speech is given the word boundary of each word through forced alignment. For a speech synthesis corpus (TTS corpus), speech data of about 5 hours of speech by a female professional narrator who is an English native speaker was used. FIG. 12 shows other information on the both corpuses.

The word vectorization model f_{w→af} used three layers of Bidirectional LSTM (BLSTM) as an intermediate layer, and the output of the second intermediate layer as a bottleneck layer. The number of units of each layer except the bottleneck layer was 256, and Rectied Linear Unit (ReLU) was used as an activation function. In order to verify performance changes due to the number of dimensions of the word vector, five models with different numbers (16, 32, 64, 128, and 256) of units in a bottleneck layer were learned. In order to support unknown words, all words that appear at a frequency of twice or less in the learning data are regarded as unknown words (“UNK”) and are regarded as one word. Besides, since unlike text data, speech data contains silence (a pause) inserted in the beginning of a sentence, in the middle of a sentence, and at the end of a sentence, a pause is also treated as a word (“PAUSE”) in this simulation. As a result, a total of 26,663 dimensions including “UNK” and “PAUSE” were taken as inputs to the word vectorization model f_{w→af}. F0 of each word was resampled to a fixed length (32 samples) and the first to fifth dimensions of the DCT value were used as the output of the word vectorization model f_{w→af}. For learning, 1% randomly selected from all data was used as development data for cross validation (early stopping), and other data was used as learning data. At the time of re-learning using a speech synthesis corpus, like in the speech synthesis model which will be described later, 4,400 sentences and 100 sentences were used as learning and development data, respectively. For comparison with the proposed method, as in conventional methods (see References 1 and 2), an 80-dimensional word vector (Reference 3) consisting of 82,390 words was used as a word vector learned from only text data.

(Reference 1) P. Wang et al:, “Word embedding for recurrent neural network based TTS synthesis”, in ICASSP 2015, p. 4879-4883, 2015.
(Reference 2) X. Wang et al:, “Enhance the word vector with prosodic information for the recurrent neural network based TTS system”, in INTERSPEECH 2016, p. 2856-2860, 2016.
(Reference 3) Mikolov, et al:, “Recurrent neural network based language model”, in INTERSPEECH 2010, p. 1045-1048, 2010.
Since no words corresponding to unknown words (“UNK”) and pauses (“PAUSE”) exist therein, the mean of the word vectors of all words was used as an unknown word, and a word vector for a sentence end sign (“</s>”) was used as a pause in this simulation. For the speech synthesis model, a network composed of two layers of fully connected layer and two layers of Unidirectional LSTM (Reference 4) was used.
(Reference 4) Zen et al: “Unidirectional long short-term memory recurrent neural network with recurrent output layer for low-latency speech synthesis”, in ICASSP 2015, p. 4470-4474, 2015.
The number of units in each layer was 256, and ReLU was used as an activation function. As the feature vector of speech, a total of 47 dimensions of 0th to 39th dimensions of mel-cepstrum, a five-dimensional aperiodicity index, a log F0, and a voiced/unvoiced flag obtained from the smoothed spectrum extracted by STRAIGHT (Reference 5) were used.
(Reference 5) Kawahara et al:, “Restructuring speech representations using a pitch-adaptive time-frequency smoothing and an instantaneous-frequency-based F0 extraction: Possible role of a repetitive structure in sounds”, Speech Communication, 27, p. 187-207, 1999.

The sampling frequency of the speech signal was 22.05 kHz, and the frame shift was 5 ins. Here, 4,400 sentences and 100 sentences were used as learning and development data of the speech synthesis model, respectively, and 83 other sentences were used as evaluation data. For comparison with conventional methods, the following six types were used as inputs to the speech synthesis model.

1. Phoneme only (Quinphone)
2. The above 1+a prosodic information label (Prosodic)
3. The above 1+a text data word vector (TxtVec)
4. The above 1+a word vector of the proposed method (PropVec)
5. The above 1+a re-learned word vector of the proposed method (Prop VecFT)
6. The above 5+prosodic information label (PropVecFT+Prosodic) For the prosodic information label, positional information on syllables, words, and phrases, stress information on each syllable, and the endtone of ToBI were used. In this simulation, which uses Unidirectional LSTM as a speech synthesis model, the word vector of the preceding word cannot be taken into consideration. To avoid this problem, in the method (3. to 6.) using word vectors, in addition to the word vector of the word of interest, the word vector of one word ahead is also used as an input vector to the speech synthesis model.

### (Word Vector Comparison)

First, the word vector obtained in the proposed method (the fourth embodiment) was compared with the word vector learned from only text data. Words with similar prosodic information (the number of syllables and stress position) but different meanings, and on the contrary, words with similar meanings but different prosodic information were used as comparison target, and the cosine similarity of these word vectors were compared. As a word vector in the proposed method, a 64-dimensional word vector learned from only the speech recognition corpus was used. In addition, since BLSTM is used in the proposed method, word vectors obtained depending on the series of the preceding and succeeding words also change. For this reason, word vectors obtained from the words in “{ }” in the two pseudo-created sentences below were used as comparison targets.

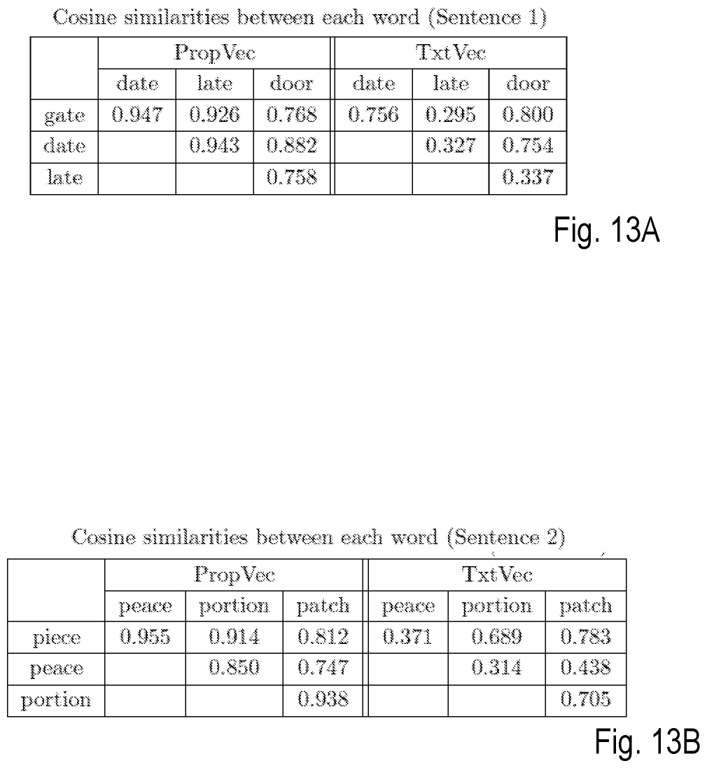

(1) I closed the {gate/date/late/door}.
(2) It's a {piece/peace/portion/patch} of cake.
FIGS. 13A and 13B show the cosine similarity between word vectors obtained by these methods for the sentences (1) and (2), respectively. First, regarding the proposed method, comparison between words with similar prosodic information (e.g., piece and peace) shows that very high cosine similarity is obtained. In contrast, words having similar meanings (e.g., piece and patch) exhibit similarity lower than that between words with similar prosodic information, demonstrating that the vectors obtained using the proposed method can reflect the similarity of prosody between words. On the other hand, word vectors learned from only text data do not necessarily reflect the similarity of the prosodic information, which shows that they do not take prosody similarity into consideration.

### (Performance Evaluation in Speech Synthesis)

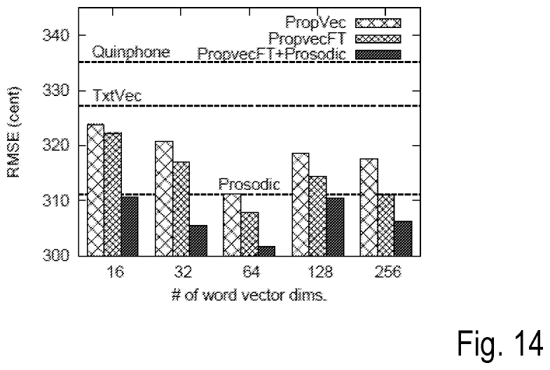

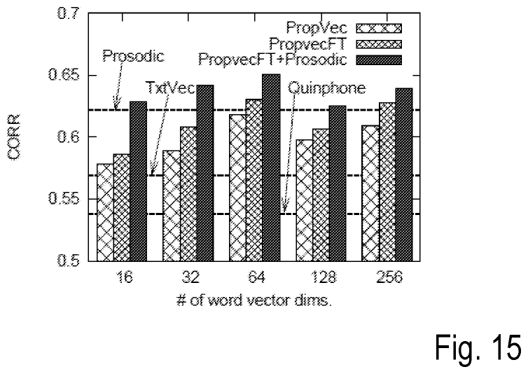

Next, objective evaluation was performed to evaluate the effectiveness of use of the proposed methods for speech synthesis. RMS error of log F0 and correlation coefficient generated by the original speech and each method were used as an objective evaluation scale. The RMS error and the correlation coefficient obtained by each method are shown in FIGS. 14 and 15, respectively.

First, three types of conventional methods were compared. The word vector (TxtVec) obtained by a conventional method exhibits a higher F0 generation accuracy than that of Quinphone, but lower generation accuracy than use of prosodic information (Prosodic), which is a tendency similar to that was observed in a conventional research (Reference 1). Comparison between the conventional methods and the proposed method (PropVec, the fourth embodiment) shows that the proposed method exhibits a higher F0 generation accuracy than TxtVec independently of the number of dimensions of the word vector. Moreover, under the experimental conditions here, the highest performance, which was comparable to that of Prosodic, was obtained when the number of dimensions of the word vector was set to 64. In addition, it was also shown that, with a re-learned word vector (PropVecFT, the fifth embodiment), a higher F0 generation accuracy was obtained independently of the number of dimensions of the word vector. In particular, when the number of dimensions of the word vector is 64, an F0 generation accuracy higher than that of Prosodic is obtained. These results show that the proposed method which uses large-scale speech data for word vectorization model learning is effective in speech synthesis. Finally, the effectiveness of use of the word vector and prosodic information obtained by the proposed method in combination will be verified. Comparison between PropVecFT and PropVecFT+Prosdic showed that, in all cases, PropVecFT+Prosdic gained high F0 generation accuracy. Similarly, comparison with Prosodic showed that PropVecFT+Prosodic had high accuracy in all cases, and use of prosodic information and the word vector of the proposed method in combination was also effective.

### Other Modifications

The present invention is not limited to the above embodiments and modifications. For example, the various types of processing described above may not only be executed in time sequence in accordance with the description, but also may be executed in parallel or separately depending on the processing capability of the device executing the processing or as needed. In addition, various modifications can be made as appropriate without departing from the scope of the present invention.

### Program and Recording Medium

In addition, various processing functions in each device described in the above embodiments and modifications may be implemented using a computer. In that case, the processing of the function that each device should have is described using a program. By executing this program using a computer, various processing functions in each of the above-described devices are implemented on the computer.

The program for describing this processing can be recorded on a computer-readable recording medium. The computer-readable recording medium may be anything, for example, a magnetic recording device, an optical disc, a magneto-optical recording medium, or a semiconductor memory.

This program is distributed, for example, by selling, transferring, or renting a portable recording medium, such as a DVD or CD-ROM, that stores the program. Moreover, this program may be pre-stored in a storage device in a server computer, and the program may be distributed by transferring the program from the server computer to another computer via a network.

A computer that executes such a program first temporarily stores the program recorded in a portable recording medium or the program transferred from the server computer in its own storage. Then, during execution of the processing, the computer reads the program stored in its own storage and executes processing according to the read program. According to another embodiment of this program, the computer may read the program directly from the portable recording medium and execute processing according to the program. Furthermore, each time a program is transferred from the server computer to this computer, processing according to the received program may be executed accordingly. Alternatively, the above-described processing may be executed by a so-called ASP (Application Service Provider) service that implements a processing function only by instruction of execution of a program and acquisition of the results from the server computer, without transfer of the program to this computer. It should be noted that the program includes information that is used for processing in electronic computational machines and conforms to the program (for example, data that is not a direct command to the computer but defines processing in the computer).

Although each device is configured by executing a predetermined program on a computer, at least a part of these contents of processing may be achieved using a hardware.

1. A word vectorization model learning device comprising:
a learning part for learning a word vectorization model by using a vector w_{L,s}(t) indicating a word y_{L,s}(t) included in learning text data, and an acoustic feature amount af_{L,s}(t) that is an acoustic feature amount of speech data corresponding to the learning text data and that corresponds to the word y_{L,s}(t), wherein
the word vectorization model includes a neural network that receives a vector indicating a word as an input and outputs the acoustic feature amount of speech data corresponding to the word, and the word vectorization model is a model that uses an output value from any intermediate layer as a word vector.

2. The word vectorization model learning device according to claim 1, further comprising a word expression converting part that converts the word y_{L,s}(t) included in the learning text data to a first vector w_{L,1,s}(t) indicating the word y_{L,s}(t), and converts the first vector w_{L,1,s}(t) to the vector w_{L,s}(t) by using a second word vectorization model, wherein
the second word vectorization model is a model that includes a neural network learned based on language information without use of the acoustic feature amount of speech data.

3. A word vectorization device that uses a word vectorization model learned in the word vectorization model learning device according to claim 1 or 2, the word vectorization device including a word vector converting part that converts a vector w_{o_1,s}(t) indicating a word y_{o,s}(t) included in text data to be vectorized to a word vector w_{o_2,s}(t) by using the word vectorization model.

4. A speech synthesis device that generates synthesized speech data by using a word vector vectorized using the word vectorization device according to claim 3, the speech synthesis device comprising:
a synthesized speech generating part that generates synthesized speech data through a speech synthesis model including a neural network that receives phonemic information on a certain word and a word vector corresponding to the word as inputs and outputs information for generating synthesized speech data related to the word, by using phonemic information on the word y_{o,s}(t) and the word vector w_{o_2,s}(t), wherein
the word vectorization model is obtained by re-learning a word vectorization model learned using the vector w_{L,s}(t) and the acoustic feature amount af_{L,s}(t), the re-learning using a vector indicating a word and an acoustic feature amount of speech data for speech synthesis that is speech data corresponding to the word.

5. A word vectorization model learning method to be executed by a word vectorization model learning device, the word vectorization model learning method comprising:
a learning step for learning a word vectorization model by using a vector w_{L,s}(t) indicating a word y_{L,s}(t) included in learning text data, and an acoustic feature amount af_{L,s}(t) that is an acoustic feature amount of speech data corresponding to the learning text data and that corresponds to the word y_{L,s}(t), wherein
the word vectorization model includes a neural network that receives a vector indicating a word as an input and outputs the acoustic feature amount of speech data corresponding to the word, and the word vectorization model is a model that uses an output value from any intermediate layer as a word vector.

6. A word vectorizing method to be executed by a word vectorization device, the word vectorizing method using a word vectorization model learned by the word vectorization model learning method according to claim 5, the word vectorizing method comprising:
a word vector converting step of converting a vector w_{o_1,s}(t) indicating a word y_{o,s}(t) included in text data to be vectorized to a word vector w_{o_2,s}(t) by using the word vectorization model.

7. A speech synthesis method to be executed by a speech synthesis device, the speech synthesis method generating synthesized speech data by using a word vector vectorized using the word vectorization device according to claim 6, the speech synthesis method comprising:
a synthesized speech generating step that generates synthesized speech data through a speech synthesis model including a neural network that receives phonemic information on a certain word and a word vector corresponding to the word as inputs and outputs information for generating synthesized speech data related to the word, by using phonemic information on the word y_{o,s}(t) and the word vector w_{o_2,s}(t), wherein
the word vectorization model is obtained by re-learning a word vectorization model learned using the vector w_{L,s}(t) and the acoustic feature amount af_{L,s}(t), the re-learning using a vector indicating a word and an acoustic feature amount of speech data for speech synthesis that is speech data corresponding to the word.

8. A program for causing a computer to function as the word vectorization model learning device according to claim 1 or 2.

9. A program for causing a computer to function as the word vectorization device according to claim 3.

10. A program for causing a computer to function as the speech synthesis device according to claim 4.
